(19) United States
(12) Patent Application Publication
(10) Pub. No.: US 2024/0132115 A1
(43) Pub. Date: Apr. 25, 2024

(54) COMPUTER-IMPLEMENTED METHOD FOR SWITCHING A CONTROL FUNCTION OF A VEHICLE BETWEEN A DRIVER AND AN AT LEAST PARTIALLY AUTOMATED CONTROL METHOD OF A VEHICLE

(71) Applicant: Robert Bosch GmbH, Stuttgart (DE)

(72) Inventors: Norbert Schneider, Wuerzburg (DE); Liza Christine Dixon, Stuttgart (DE); Sven Frieder Herrmann, Stuttgart (DE)

(21) Appl. No.: 18/479,923

(22) Filed: Oct. 2, 2023

(30) Foreign Application Priority Data
Oct. 20, 2022 (DE) 102022211167.2

(51) Int. Cl. B60W 60/00; B60W 40/09

(52) U.S. Cl. CPC B60W 60/0053; B60W 40/09; B60W 2540/221; B60W 2540/229

(57) ABSTRACT

A computer-implemented method for switching a control function of a vehicle between a driver and an at least partially automated control method for controlling the vehicle. In the method, a stored driver profile is recorded, wherein a state of the driver and/or a state of the vehicle and/or a state of the control method are recorded, wherein a switch of the control function between the driver and the control method is carried out depending on the driver profile and depending on the state of the driver and/or the state of the vehicle and/or the state of the control method.

### CROSS REFERENCE

The present application claims the benefit under 35 U.S.C. § 119 of German Patent Application No. DE 10 2022 211 167.2 filed on Oct. 21, 2022, which is expressly incorporated herein by reference in its entirety.

### FIELD

The present invention relates to a method for switching a control function of a vehicle between a driver and an at least partially automated control method of a vehicle, to a method for learning a driver profile, to a computing unit designed to execute the method, and to a computer program.

### BACKGROUND INFORMATION

A method for switching between an autonomous control method and a manual control method of a vehicle, wherein during the switchover it is taken into account whether the driver is willing to execute the manual control method, is described in U.S. Patent Application Publication No. US 2021/0061299 A1.

### SUMMARY

One object of the invention is to provide an improved method for switching a control function of a vehicle between a driver and an at least partially automated control method of a vehicle.

The object of the present invention may be achieved by a computer-implemented method for switching a control function of a vehicle between a driver and an at least partially automated control method of a vehicle, which is designed to control a vehicle in an at least partially automated, in particular fully automated, manner.

Provided according to the present invention is a computer-implemented method for switching a control function of a vehicle between a driver and an at least partially automated control method for controlling the vehicle. According to an example embodiment of the present invention, a stored driver profile is recorded, wherein a state of the driver and/or a state of the vehicle and/or a state of the control method are recorded, wherein a switch of the control function between the driver and the control method is carried out depending on the driver profile and depending on the state of the driver and/or the state of the vehicle and/or the state of the control method. In addition, depending on the driver profile and depending on the state of the driver and/or the state of the vehicle and/or the state of the control method, a switch of the control function between the driver and the control method can be prevented. The control function can, for example, represent a longitudinal and/or a lateral guidance of the vehicle, but other functions of the vehicle may also be controlled with the control function.

Depending on which driver profile is stored, the request for the handover and/or the request for the takeover of the control function is executed differently.

In this way, it is possible to take into account a driver profile, which may be preset or learned during operation of the vehicle, upon a transfer of responsibility for the control function between the driver and the control method. This makes it possible to take an individual driver profile into account when requesting to take over a control function and/or when requesting to hand over a control function. This allows the method to be adapted to the desires of the driver. For example, the driver may select one of a number of predetermined driver profiles by making a selection or input. In addition, the driver profile may be learned from a learned driver behavior and/or a predetermined driver profile may be adapted. The use of a driver profile may improve the method. Overall, the operating comfort for the driver may be increased.

In one example embodiment of the present invention, upon the switch of the control function of the vehicle between the driver and the control method for controlling the vehicle, a stored conflict situation that prohibits or requires a switch of the control function between the driver and the control method is taken into account. The conflict situation is described by a predetermined state of the driver and/or a predetermined state of the vehicle and/or a predetermined state of the control method. In this way, it is also possible to take into account known or determined conflict situations individually for a particular driver in order to achieve a switch of the control function between the driver and the control method that is individually adapted to the driver. The conflict situation may be predetermined or determined during operation of the vehicle. The conflict situation may specify that a switch of the control function between the control method and the driver is desired or required, or not desired or prohibited. The conflict situation may be described by a predetermined range of states of the driver and/or a predetermined range of states of the vehicle and/or a predetermined range of states of the control method. This achieves a simplification of the method.

In one example embodiment of the present invention, the frequency of requests for a takeover of the control function that is currently being executed by the driver, and/or a frequency of requests for a handover of the control function to the driver, wherein the control function is currently being executed by the control method, is specified. Thus, drivers who want to drive longer or more often in a self-driving mode, i.e., in a manual driving mode without assistance from the partially automated control method, may achieve better adaptation of the desired control method. In addition, drivers who want to drive longer or more often in the at least partially automated driving mode or in a fully automated driving mode may experience a better adaptation of the control method. In this way, the satisfaction of the driver and thus the relief or assistance desired by the driver in controlling the vehicle is improved by the control method. Sports-oriented drivers, for example, desire self-driving mode as long as possible or as often as possible, whereas more relaxed drivers desire at least partially automated control of the vehicle as often as possible or as long as possible. This means that the various driver desires may be taken into account by the control method in the form of different driver profiles.

In a further example embodiment of the present invention, different driver profiles may be used to specify different states of the vehicle in which the control method executes requests for a takeover of a control function that is currently being executed by the driver and/or requests for a handover of a control function to the driver being executed by the method.

The states of the vehicle are preset, for example, by the driver profile or are learned depending on a behavior of the driver when operating the vehicle. For example, the state of the vehicle may be a position of the vehicle or a road situation in the area of the vehicle, which is taken into account depending on the driver profile for the request for a takeover of the control function and/or for the request for a handover of the control function.

For example, a driver may prefer that the at least partially automated control of the vehicle using the control method be performed only on highways or only on highways and on rural roads. In addition, a driver may prefer that the at least partially automated control method is not active when the vehicle enters or exits a road, enters an intersection, etc., but that the control function is executed by the driver himself in self-driving mode when the vehicle is in this state. Furthermore, the state of the vehicle may be considered to mean that the safety for a reliable recognition of the vehicle's environment is above a specified safety value such as 80%. If the probability for the reliable recognition of the vehicle's environment is below the threshold value, the control function of the vehicle may be executed by the driver himself in self-driving mode in accordance with the stored driver profile. Depending on the driver profile, the threshold value may also be at other values such as 90% or 70%.

In a further example embodiment of the present invention, in the case of a request for a takeover of a control function that is being executed by the driver, or when a request is made to hand over a control function to the driver that is currently being executed by the control method, a check is made to determine whether a predetermined state of the vehicle exists for which the requested switch is desired or permitted. The request for the handover and/or the request for the takeover of the control function is executed if the predetermined state of the vehicle is present. In this way, a very specific definition of the carrying out of the requests for a takeover and/or a handover of the control function may be achieved. For example, the state of the vehicle may relate to an environment of the vehicle in which the vehicle is moving, in particular representing the number of lanes of the roadway on which the vehicle is moving, the presence of lane markings, the presence of lane boundaries (e.g., structural separation of directional lanes) in the area of the vehicle, a weather situation, such as rain, snow, or black ice in the area of the vehicle, a speed of the vehicle, an acceleration of the vehicle in the longitudinal and/or lateral direction, and/or a level of the partially automated control method, in particular a level 2 to level 5 automated control.

In a further example embodiment of the present invention, depending on the driver profile, the requests for taking over the control function that is currently being executed by the driver and/or the requests for a handover of a control function to the driver being executed by the method are executed at different states of the driver. At least one of the following values exerted by the driver may be recorded as the state of the driver: steering torque, steering angle, pressure on the brake pedal or alternative input methods such as using a joystick to transmit a deceleration request, actuation situation of the gas pedal or alternative input methods such as using a joystick to transmit an acceleration request, volume of the driver's voice, in particular in the case of acoustic control of an operation of the vehicle, movement behavior of the driver's arms and/or head, movement behavior during gesture control, sitting position or reclined position of the driver, tilt angle of the driver's upper body, direction of gaze of the driver, number and/or frequency of closing of the driver's eyes, state of health of the driver such as pulse, blood pressure, or body temperature, drug concentration such as driver's alcohol concentration, and/or state of wakefulness or state of sleep of the driver.

A state of the control method may correspond to the level of automation, i.e., one of the levels 1 to 5 of automation. In addition, the state of the control method may correspond to a safe state or an unsafe state, wherein in the safe state there is a correct operation of the control method and in the unsafe state there is an incorrect operation of the control method or an operation inappropriate to the situation. Furthermore, an unsafe state of the control method may exist if the control method is operated outside a predetermined operating range (functional range) of the vehicle. In addition, the state of the control method is evaluated as unreliable if the operation of the computing unit and/or the control unit and/or the control method and/or the sensors of the vehicle and/or the control system are classified as unreliable.

In a further example embodiment of the present invention, in the case of a request for a takeover of a control function that is being executed by the driver, or in the case of a request for a handover of a control function to the driver that is being executed by the control method, a check is made to determine whether a driver state predetermined by the driver profile exists for the requested switch. The request for the handover and/or the takeover of the control function is executed if the predetermined state of the driver for which a request for the handover and/or the takeover of the control function is desired by the control method is present.

In one example embodiment of the present invention, the driver profile may be determined and stored during operation of the vehicle. In this case, for example, it is checked in which states of the driver and/or in which states of the vehicle and/or in which states of the vehicle the driver requests a takeover of the control function that is being executed by the method from the method, or in which situations the driver takes over a handover of the control function that is being executed by the method. The states of the driver and/or the states of the vehicle recorded in this case are used to specify the driver profile.

For example, a driver may desire varying degrees of assistance from the vehicle's at least partially automated control method depending on the day of the week or time of day. For example, between 8:00 p.m. and 6:00 a.m., a driver may desire the vehicle to be controlled as much as possible by the at least partially automated control method. In contrast, between 6:00 a.m. and 8:00 p.m., for example, the driver may desire as little assistance as possible in controlling the vehicle by the at least partially automated control method. In addition, the driver may, for example, desire to be assisted as much as possible in controlling the vehicle by the at least partially automated control method if the driver is tired or in a poor state of health. In addition, the driver may desire less assistance from the at least partially automated control method on the weekend compared with one of the workdays from Monday to Friday.

In a further example embodiment of the present invention, depending on the driver profile, when various functional limits of the at least partially automated control method are reached, the method offers to the driver the handover of the control function of the vehicle that is being executed by the at least partially automated method. Thus, depending on the driver profile, the method can offer to the driver the handover of the control function of the vehicle already at a relatively large distance to a functional limit or only when the functional limit is actually reached.

Also provided according to the present invention is a computer-implemented method for determining a driver profile for carrying out a switch of a control function of a vehicle between a driver and an at least partially automated control method for controlling the vehicle. According to an example embodiment of the present invention, during operation of the vehicle, in the case of a request from the control method and/or in the case of a request from the driver for a switch of the control function, it is checked whether or not the switch is taking place, and wherein a state of the driver and/or a state of the vehicle and/or a state of the control method is stored in the driver profile together with the request from the control method and/or the request from the driver for the switch of the control function and the information as to whether or not the switch took place. This allows the driver profile to be determined and/or supplemented during operation. For example, in this way it may be determined at which states of the driver and/or at which states of the vehicle and/or at which states of the control method the driver accepts a switch. In addition, in this way it may be determined at which states of the driver and/or at which states of the vehicle and/or at which states of the control method the driver does not accept a switch. This also allows conflict situations to be determined individually for each driver during operation of the vehicle. The stored conflict situations with which the driver refuses the switch are taken into account by the control method upon future requests. Thus, for example, during further operation of the vehicle in conflict situations, the control method does not request a switch of the control function.

In a further example embodiment of the present invention, the control method offers to the driver the handover of the control function when a functional limit (operational design domain) is reached, wherein it is monitored whether or not the driver accepts the handover, wherein at least one state of the driver and/or at least one state of the vehicle are recorded, wherein the recorded state of the driver and/or the recorded state of the vehicle are stored as a driver profile, and wherein the information is stored as to whether or not the driver has accepted the handover of the control function. Thus, in particular in the range of the functional limit of the at least partially automated control function, conflict situations in which the driver wants or does not want a switch of the control function may be determined.

For example, a group of states of the driver and/or a range of values of states of the vehicle for which the driver accepts the takeover of the control function of the vehicle and/or allows the handover of the control function to the control method may be stored as a driver profile.

In a further example embodiment of the present invention, at least one of the following states generated by the driver is recorded as the state of the driver: steering torque by the driver, steering angle by the driver, pressure on the brake pedal by the driver, actuation state of the gas pedal by the driver, the volume of the driver's voice, in particular in the case of the acoustic control of the vehicle, movement behavior of the driver, in particular in the case of gesture control of the vehicle, sitting position of the driver, direction of gaze of the driver, number and/or frequency of closing of the driver's eyes, state of health of the driver, in particular blood pressure, pulse, or temperature of the driver, drug consumption, in particular alcohol content of the driver, state of fatigue, in particular state of wakefulness or state of sleep of the driver, etc. Longitudinal guidance (acceleration/braking) and lateral guidance may also be performed using alternative input methods such as a joystick. These input situations by the driver may also be recorded as the driver's state.

By taking into account these states of the driver, improved assistance for the driver may be achieved using the at least partially automated control method.

In a further example embodiment of the present invention, at least one of the following is recorded as the state of the vehicle: position of the vehicle, such as within a town or city, on a country road, on a highway, in a tunnel, etc., road situation in the area of the vehicle, in particular entry into a road or exit from a road or entry into an intersection, number of lanes of the road on which the vehicle is moving, presence of lane markings, presence of lane boundaries, weather situation in the area of the vehicle, such as rain, snow, ice, wind force, speed of the vehicle, acceleration of the vehicle in the longitudinal direction and/or in the lateral direction. By taking into account these states of the vehicle, an improved driver profile may be determined and stored.

In a further example embodiment of the present invention, when different distances to the functional limit of the at least partially automated control method are reached, the handover of the control function of the vehicle is offered to the driver, wherein it is monitored at which distance to the functional limit the driver accepts, or does not accept, the handover. The recorded distance to the functional limit at which the driver accepts the handover is stored in the driver profile or used to form the driver profile. In this way, the conflict situations may be recorded more precisely.

In addition, a computing unit that is designed to execute the described method is provided according to the present invention.

Further, a computer program that has instructions that, when run on a computing unit, execute the described method is provided according to the present invention.

Further measures illustrating and improving the present invention are explained below with the description of exemplary embodiments.

### BRIEF DESCRIPTION OF THE DRAWINGS

FIG. 1 shows a schematic representation of a vehicle according to an example embodiment of the present invention.

FIG. 2 shows a schematic explanation of the operation of the described method with a block diagram, according to an example embodiment of the present invention.

FIG. 3 shows a schematic representation of a partial function of the method using a second block diagram, according to an example embodiment of the present invention.

FIG. 4 shows a first method sequence for carrying out the method according to an example embodiment of the present invention.

FIG. 5 shows a second method sequence for carrying out the method, according to an example embodiment of the present invention.

FIG. 6 shows a further method sequence in which a handover is performed from manual control of the control function of the vehicle to an at least partially automated control method for the control function of the vehicle, according to an example embodiment of the present invention.

FIG. 7 shows a further method sequence in which the control of the control function of the vehicle remains with the control method, according to an example embodiment of the present invention.

FIG. 8 shows a further method sequence in which the vehicle is in an at least partially automated control mode at the starting point, according to an example embodiment of the present invention.

FIG. 9 shows a method with which a driver desire based on a driver profile is predicted and taken into account in order to increase driver comfort and avoid a conflict situation, according to an example embodiment of the present invention.

### DETAILED DESCRIPTION OF EXAMPLE EMBODIMENTS

An at least partially automated control method for a control function of a vehicle may comprise, for example, longitudinal and/or lateral guidance of a vehicle. In this case, the control method may execute at least one of the levels of level 1 to level 5 (SAE, J3016, 202104), wherein in level 1 the driver controls the vehicle alone in terms of longitudinal dynamics and direction and, from level 2, the driver is increasingly assisted by the at least partially automated control method in the longitudinal and/or lateral guidance and, from level 5, the longitudinal and lateral guidance of the vehicle are controlled completely by the at least partially automated control method without any influence from the driver. Thus, the at least partially automated control method ranges from assisted operation, partially automated operation, highly automated operation to fully automated operation of the longitudinal and lateral guidance of the vehicle. Thus, for example, in level 2, the at least partially automated control method may control the acceleration of the vehicle in the longitudinal direction and/or the steering of the vehicle in the lateral direction and, if the driver intervenes, for example by actuating the brake or gas pedal or by moving the steering wheel, the control may switch to manual control by the driver.

The driving modes level 0 to level 5 are briefly explained below:

The driver monitors the driving range in level 0 to level 2.

Level 0: No Automation

The driver takes over the driving dynamics task, even if assisting systems (e.g., ABS or ESP) are available.
Lateral and longitudinal guidance: driver
Monitoring of the environment: driver
Fallback level for dynamic driving task: none
Driving mode: none

Level 1: Driver Assistance

(Assistance systems) Driving mode-dependent takeover of steering or acceleration/deceleration by a driver assistance system using information regarding the driving environment, with the expectation that the driver will take over all other aspects of the dynamic driving task.
Lateral and longitudinal guidance: driver and system
Monitoring of the environment: driver
Fallback level for dynamic driving task: driver
Driving mode: several driving modes

Level 2: Partial Automation

(Partial automation) Driving mode-dependent takeover of steering and acceleration/deceleration by one or more driver assistance systems using information regarding the driving environment, with the expectation that the driver will take over all other aspects of driving dynamics tasks.
Lateral and longitudinal guidance: driver assistance systems
Environmental monitoring: driver
Fallback level for dynamic driving tasks: driver
Driving mode: several driving modes,

Level 3 to 5: System Monitors Driving Range

Level 3: Conditional Automation

(Conditional automation) Driving mode-dependent execution of all aspects of the dynamic driving task by an automated driving system, with the expectation that the driver will respond to prompts to intervene.
Lateral and longitudinal guidance: driver assistance systems
Environmental monitoring: driver assistance systems
Fallback level for dynamic driving tasks: driver
Driving mode: several driving modes

Level 4 High automation

(High automation) Driving mode-specific execution of all aspects of the dynamic driving task by an automated driving system, wherein it is not expected that the driver will respond to the prompt to intervene. Without human intervention, the vehicle continues to steer in an automated manner.

Lateral and longitudinal guidance: automated driving system
Environmental monitoring: automated driving system
Fallback level for dynamic driving tasks: automated driving system
Driving mode: several driving modes

Level 5 Full Automation

(Full automation) Complete execution of all aspects of the dynamic driving task by an automated driving system that controls all road and environmental conditions like a human driver.
Lateral and longitudinal guidance: automated driving system
Environmental monitoring: automated driving system
Fallback level for dynamic driving task: automated driving system.
Driving mode: all driving modes

An automated control of the longitudinal and/or lateral guidance of the vehicle in level 3 may, for example, consist of automatically controlling a longitudinal and/or a lateral guidance of the vehicle for a certain period of time in a specific situation, such as driving on a highway, driving into a parking lot, overtaking a vehicle, etc. The driver of the vehicle does not himself have to manually control the longitudinal and/or lateral guidance of the vehicle. However, the driver must permanently monitor the automatic control of longitudinal and/or lateral guidance in order to be able to intervene manually if necessary. The driver must be prepared to fully take over the motor vehicle at any time.

The proposed computer-implemented method, which may control the vehicle in an at least partially automated manner in accordance with any of the levels 2 to 5, takes into account, in the case of a request for a takeover of the control function from the driver or in the case of a request for a handover of the control function to the driver, a stored driver profile for the request for the handover and/or the takeover of the control function, i.e., the switch of the control function between the driver, i.e., operating elements of the driver, and the control method.

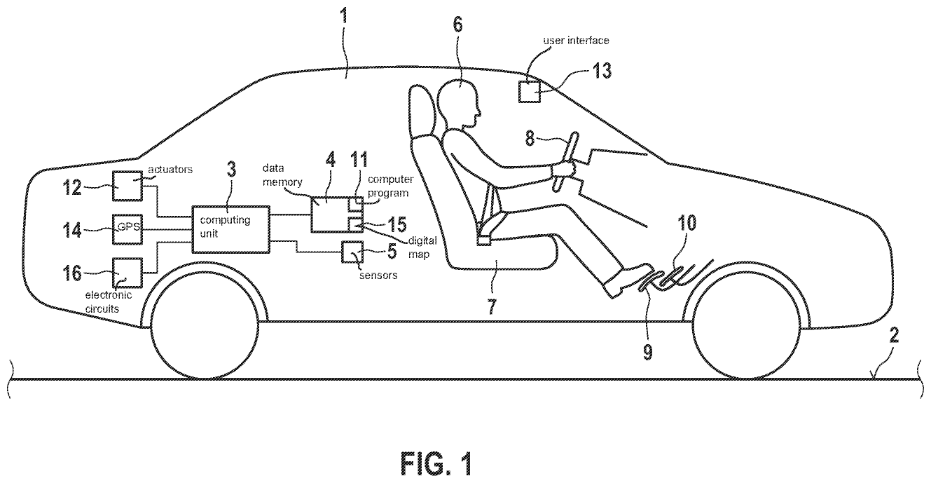

FIG. 1 shows a schematic representation of a vehicle 1, which is in the form of a motor vehicle and travels on a road 2. The vehicle 1 has a computing unit 3, which is connected to a data memory 4 and sensors 5. In the figure, only one sensor 5 is shown as an example. However, a plurality of sensors may be provided, which may record both a state of the driver and/or a state of the vehicle. Cameras, microphones, temperature gauges, heart rate monitors, blood pressure monitors, etc. may be provided to record a state of the driver. In addition, these data may be recorded by a mobile device such as a cell phone or smart watch and transmitted to an interface of the computing unit. Furthermore, the vehicle may have a tracking device such as a GPS system 14 and a digital map 15 for the road network.

Furthermore, a driver 6 is provided, who sits on a vehicle seat 7 and may, for example, operate a steering wheel 8 with his hands and a gas pedal 9 and a brake pedal 10 via his feet, in order to control the longitudinal and lateral guidance of the vehicle. Depending on the embodiment of the vehicle 1, instead of the steering wheel 8, the gas pedal 9 and the brake pedal 10, there may also be other control interfaces, e.g. man-machine interfaces for controlling the longitudinal and/or lateral guidance of a vehicle. For example, gesture control and/or acoustic control and/or haptic control of the direction of travel of the vehicle and/or acceleration and/or deceleration of the vehicle may be provided.

A program for executing a computer-implemented method is stored in the data memory 4, which program may execute at least a partially automated control of the longitudinal and/or lateral guidance of the vehicle, e.g. in accordance with one of the levels 2 to 4 described, if the program is processed by the computing unit 3. For this purpose, the computing unit 3 is connected to actuators 12, which may be used to control a steering system and/or a brake and/or a drive motor of the vehicle for controlling the longitudinal and/or lateral guidance of the vehicle. In addition, at least one user interface 13 is provided, which is connected to the computing unit 3. The user interface 13 is provided, for example, to visually and/or acoustically and/or haptically output a request to the driver and/or to receive input from the driver. The user interface 13 may be designed as a screen, a touch screen, a microphone, and/or a speaker, and/or as a camera with a gesture recognition feature and/or any other type of interface.

The computer program 11 may have or communicate with a plurality of subprograms, such as a monitoring program, a safety module, a driver module, a vehicle monitoring program and/or a control method, which are also stored in the data memory 4 and executed by the computing unit 3. However, the computer program 11 may itself execute the monitoring program, the safety module, the driver module, etc.

The control method has at least partially automated control methods for controlling at least one longitudinal and/or lateral guidance of the vehicle. In addition, the functions of the computer program 11 along with the subprograms, such as the monitoring program, the safety module, the driver module, the control method and/or the vehicle monitoring program, may be in the form of electronic circuits 16. The electronic circuits 16 are connected to the computing unit 3.

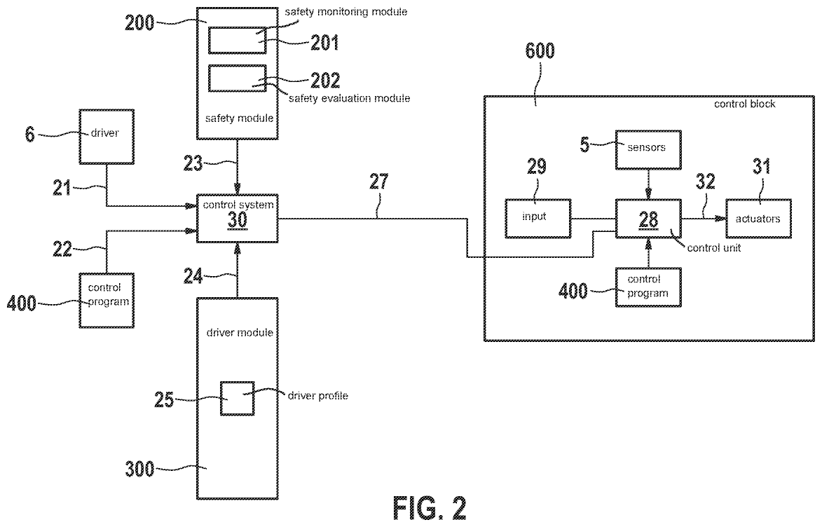

FIG. 2 shows a schematic representation of an overview of the mode of operation of a vehicle. In the following, unless explicitly stated otherwise, a control method is understood to be a control method for controlling an operation of the vehicle, in particular the control of a longitudinal and/or a lateral guidance of the vehicle.

In a control block 600, a schematic structure of a control system of a vehicle with a possible control by the driver and/or a possible control by an at least partially automated control method implemented, for example, as a control program 400 is shown. A control unit 28 receives signals from sensors 5, first control signals from input means 29 actuated by the driver, and/or second control signals generated by the control program 400. The input means may be, for example, a camera and a gesture recognition program. In addition, the input means may be switches, controllers and/or touch screens that may be operated directly by the driver. Input means 29 may further comprise sensors that record, for example, the following inputs from the driver: steering wheel angle, steering wheel torque, actuation of the brake and/or actuation of the gas pedal and/or a voice input. In addition, an input means may also comprise a user interface that records haptic, acoustic and/or visual input from the driver.

In addition, the control unit 28 receives a control signal 27 from a control system 30. The control unit 28 generates actuation signals 32 for controlling actuators 31 at least for longitudinal and/or lateral guidance of the vehicle depending on the signals from the sensors 5, depending on the first and/or the second control signals and depending on the control signal 27 from the control system 30. For this purpose, the control unit 28 may access corresponding control programs stored in the data memory 4. The actuators 31 control, for example, a power of an engine of the vehicle, and/or a power of a brake of the vehicle and/or a steering of the vehicle. Depending on the control signal 27, the control unit 28 takes into account the first control signals of the input means 29 and/or the second control signals of the control program 400. The control program 400 executes the control method. In addition, the control program 400 may represent the control method and/or be in the form of a control module.

The control system 30 receives first requests 21 from the driver 6 and/or second requests 22 from the control program 400. The driver 6 may generate a first request 21 by means of a corresponding actuation of input means of the vehicle or actuation of the user interface. The second requests 22 of the control program 400 are generated by the computing unit 3 on which the control program 400 is running. The control system 30 may be designed as a further computing unit or may be executed by the computing unit 3.

The first requests 21 may represent requests from the driver for a switch of the control function between the driver and the control method (control program 400), i.e., for a takeover of a control function of the vehicle that is being executed by the control method, or requests from the driver for a handover of the control function to the control method that is being executed by the driver. The control function may control a longitudinal and/or a lateral guidance of the vehicle.

The second requests 22 may represent requests from the control method (control program 400) for a takeover of the control function that is being executed by the driver, or requests from the control method for a handover of the control function of the vehicle to the driver that is being executed by the method. The control function may control a longitudinal and/or a lateral guidance of the vehicle.

The first and second requests 21, 22 are transmitted to the control system 30. The control system 30 is connected to a safety module 200 and to a driver module 300. The safety module may be in the form of an electronic circuit and/or in the form of a computer program. The driver module may be designed as an electronic circuit and/or a computer program. Depending on the selected embodiment, the safety module 200 may also be dispensed with. The safety module 200 may monitor the reliability of the mode of operation of the computing unit 3 and/or the control unit 28 and/or the control program 400 and/or a reliable operation of the sensors 5. For this purpose, predetermined test procedures, which may be used to check the reliable operation of the computing unit 3 and/or the control unit 28 and/or the control program 400 and/or a reliable operation of the sensors 5, may be stored. Based on the evaluation(s) of the reliable operation of the computing unit 3 and/or the control unit 28 and/or the control program 400 and/or a reliable operation of the sensors 5, a safety value 23 for the correct and reliable operation of the control method for controlling an operation of the vehicle will be determined according to a specified method.

The safety module 200 outputs at least one safety value 23 to the control system 30. The safety value 23 indicates, for example, how reliably the control program 400 is executed by the computing unit 3. In addition, the safety value 23 may indicate how safely, i.e. how reliably, an environment of the vehicle is recorded using the sensors 5. To determine the safety value, corresponding evaluation programs are stored in the data memory, which are executed by the computing unit. The safety value 23 may take values between 0 and 1, wherein a value less than or equal to 0.5 specifies an unsafe state and a value greater than 0.5 specifies a safe state of the control method.

For example, within the safety program 200, there may be a safety monitoring module 201 and a safety evaluation module 202. The safety monitoring module 201 receives inputs regarding a status of the control system 400, in particular the control method, and the driver program 300, which the safety evaluation module 202 classifies as either normal, i.e., within a safe and acceptable operating parameter, or at risk, i.e., exceeding a predefined threshold value. The safety monitoring module 201 and the safety evaluation module 202 may be software programs and/or hardware circuits.

Further, the control system 30 receives a prediction value 24 from the driver module 300. The prediction value 24 depends, for example, on a learned driver profile or a stored driver profile and/or on a state of the driver. For this purpose, the driver module 300 accesses a stored driver profile 25, which is stored in the data memory 4, for example. Depending on the selected embodiment, the prediction value 24 may be formed only by the driver profile 25. The prediction value 24 may take values between 0 and 1, wherein a value between 0 and 0.5 and 0.5 determines that the driver desires as little or no assistance as possible from the control program 400 for the control function of the vehicle. The prediction value 24 with a value greater than 0.5 specifies that the driver desires as much assistance as possible from the control program 400 for the control function of the vehicle. The larger the prediction value 24, the greater the likelihood that the driver desires assistance from the control program 400 for the control function of the vehicle. Depending on the selected embodiment, various threshold values, such as 0.5 or 0.75, may be set for the predicted value 24, above which the control program 400 actively requests a takeover of the control function of the vehicle from the driver 6 to the control program 400.

In addition, the stored driver profile 25 may be determined during operation of the vehicle using the sensors 5. In this case, at least one state of the driver and/or at least one state of the vehicle may be learned during a handover and/or a takeover of a control function of the vehicle between the driver 6 and the control program 400.

At least one of the following parameters may be recorded as the driver's state: steering torque by the driver, steering angle by the driver, pressure on the brake pedal by the driver, actuation of the gas pedal by the driver, volume of the driver's voice, movement behavior of the driver, in particular in the case of gesture control by the driver, sitting position of the driver, direction of gaze of the driver, number and/or frequency of closing of the driver's eyes, state of health of the driver, state of wakefulness of the driver and/or state of sleep of the driver.

At least one of the following parameters may be recorded as the state of the vehicle: position of the vehicle, road situation in the area of the vehicle, in particular entry into a road, exit from a road, entry into an intersection, number of lanes of the road in the area of the vehicle, presence of lane markings, presence of lane boundaries, weather situation in the area of the vehicle, in particular rain, snow, wind force, speed of the vehicle, acceleration of the vehicle in longitudinal direction and/or in lateral direction.

For example, as a learned driver profile 25, it is recorded at which states of the driver and/or at which states of the vehicle a driver outputs a request for the handover of the control function of the vehicle from the control method to the driver and/or the driver accepts the handover of the control function of the vehicle from the control method to the driver in the case of a request of the computer-implemented method. These data are stored in the data memory 4, for example, and may represent a learned driver profile or change a stored driver profile. Preferably, a driver profile may be determined from the stored data according to predetermined procedures.

The control system 30 decides, depending on the requests 21, 22 and depending on the safety value 23 and/or the prediction value 24, whether the driver and/or whether the control program 400 should control the control function of the vehicle.

For this purpose, the control system 30 generates a control signal 27. The control signal 27 may take values between 0 and 1. A value of 0 means that the driver has full control over the longitudinal and/or lateral guidance of the vehicle. A control signal 27 having a value of 1 determines that the control program 400 has full control over the longitudinal and/or lateral guidance of the vehicle. A control signal 27 having a value of 0.5 specifies that the driver and the control program 400 each have partial control over the control function of the vehicle.

The control signal 27 is transmitted to the control unit 28. In addition, depending on the safety value 23 and/or the prediction value 24, the control system 30 may decide whether or not to hand over the control function at least partially or completely from the driver to the control program 400 or vice versa.

The control system 30 transmits a corresponding control signal 27 to the control unit 28. The control unit 28 controls the longitudinal and/or lateral guidance of the vehicle using the corresponding actuators 31 of the vehicle depending on control signals of the input means 29, which are actuated by the driver, and/or depending on control signals of the control program 400 and depending on the control signal 27 according to predetermined procedures.

Depending on the value of the control signal, i.e. depending on whether the driver 6 or the control program 400 has the responsibility and authorization for the control function of the vehicle, the control unit 28 takes into account the control values of the input means 29 actuated by the driver and/or the control commands of the control program 400.

Depending on the value of the control signal 27, the control unit 28 executes one of the levels 0 to 5 (SAE, J3016, 202104) as a control strategy, in order to use the control values of the input means 29 actuated by the driver and/or the control commands of the control program 400. The control unit may have a memory, wherein in the memory certain ranges of values of the control signal 27 are assigned to a certain one of the levels 0 to 5.

The control unit 28 outputs corresponding control signals to the actuators 31 of the vehicle. In addition, sensor signals from sensors 5 of the vehicle may be taken into account by the control unit 28.

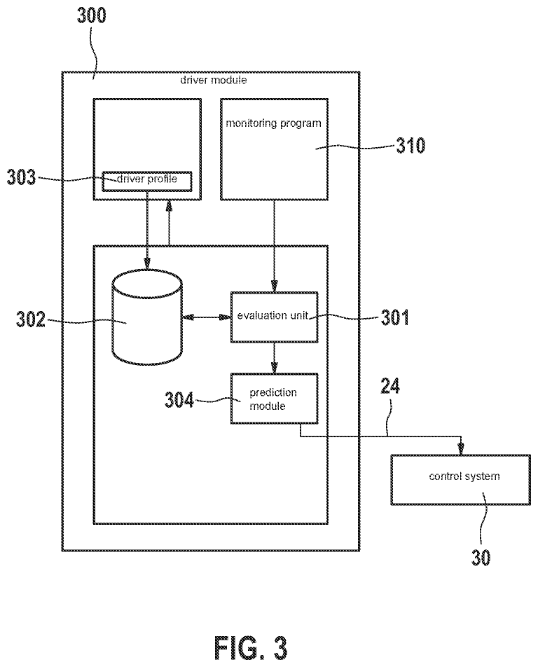

FIG. 3 shows a schematic representation of a more detailed mode of operation of the driver module 300. The driver module 300 has a monitoring program 310 that records active input from the driver, for example, via input means, and/or passive behavior of the driver, in particular a state of the driver. At least one of the following parameters may be recorded as active inputs and passive behavior of the driver: steering torque by the driver, steering angle by the driver, pressure on the brake pedal by the driver, actuation of the gas pedal by the driver, volume of the driver's voice, movement behavior of the driver, in particular in the case of gesture control by the driver, sitting position of the driver, direction of gaze of the driver, number and/or frequency of closing of the driver's eyes, state of health of the driver, state of wakefulness of the driver and/or state of sleep of the driver.

In addition, the monitoring program 310 also records the state of the vehicle. At least one of the following parameters may be recorded as the state of the vehicle: position of the vehicle, road situation in the area of the vehicle, in particular entry into a road, exit from a road, entry into an intersection, number of lanes of the road in the area of the vehicle, presence of lane markings, presence of lane boundaries, weather situation in the area of the vehicle, in particular rain, snow, wind force, speed of the vehicle, acceleration of the vehicle in longitudinal direction and/or in lateral direction.

In addition, the state of the vehicle and/or the control method may be recorded, for example, with the safety program 200, in which at least partially automated mode the vehicle is, i.e., for example, which of the autonomous driving modes level 2 to level 5 of the control method is active.

The recorded data from the monitoring program 310 is fed to an evaluation unit 301. The evaluation unit 301 may be designed as a software program or a hardware circuit. The evaluation unit 301 accesses a database 302. The database 302 is connected to at least one driver profile 303. The driver profile 303 may be a learned and/or predetermined driver profile 303. The driver may use corresponding input means of the vehicle to make preferred settings of the driver profile 303 or to select one of a plurality of predetermined driver profiles.

The evaluation unit 301 determines, depending on the data of the database 302, i.e., in particular, depending on the driver profile 303 and the data of the monitoring program 310, using a prediction module 304, for example, at which times, at which states of the vehicle and/or at which states of the driver the driver desires or does not desire an automated control of the longitudinal and/or lateral guidance of the vehicle by the control program 400, and/or at which states of the vehicle and/or of the driver the driver has carried out a handover or a takeover of a control function of the longitudinal and/or lateral guidance of the vehicle between the driver of the vehicle and the at least partially automated method for executing the control function of the longitudinal and/or lateral guidance of the vehicle in the past. Based on this information, the prediction value 24 is formed, which is transmitted to the control system 30. Preferably, moreover, a personalized adaptation of a user interface in the vehicle may be performed and/or a corresponding output to the driver may be carried out via a human-machine interface 305.

Driver behavior is predicted, for example, if an interaction of the driver with the vehicle is observed, or if, for example, geolocation indicates that it is necessary to change the automation mode and give or take control of a control function to the driver. On the basis of the database, context information is used to predict driver behavior, e.g., based on the frequency of a certain driver behavior pattern under similar conditions, e.g., how often the driver tried to take control of the vehicle.

Based on the geolocation and route information from the navigation system, for example, an area is approached where the driver is known to have taken control of the vehicle regularly in the past while driving through the area. In this case, the driver is offered control over the steering of the vehicle, in particular the longitudinal and/or lateral guidance of the vehicle.

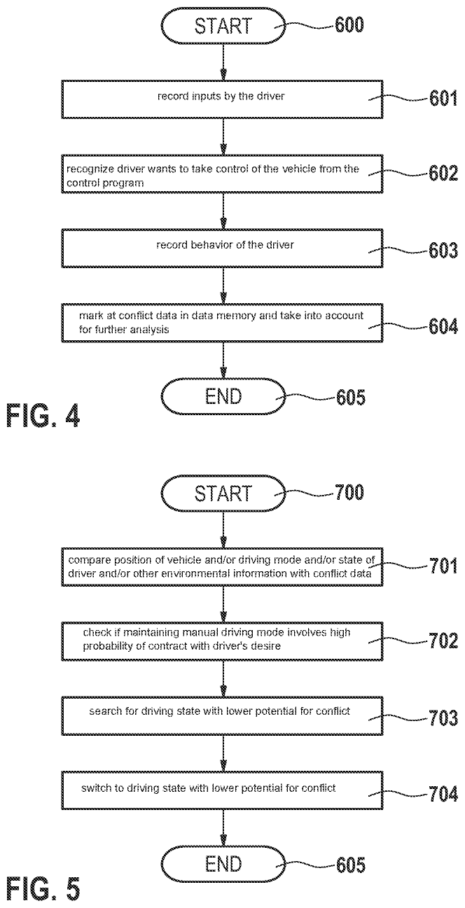

FIG. 4 shows a schematic program sequence for the case where the vehicle is in an automated driving mode, but control inputs from the driver are still detected. This is recognized as a potential conflict. Upon the start at program point 600, the vehicle is thus controlled automatically (for example, level 4) by the control program 400 in the longitudinal and lateral guidance. At program point 601, the computing unit 3 records inputs by the driver. Inputs may be recorded, for example, in the form of a predetermined steering wheel angle, a predetermined steering wheel torque, a predetermined actuation of the brake and/or a predetermined actuation of the gas pedal and/or a corresponding voice input to change the control of the vehicle using various sensors.

Thereupon, at a subsequent program point 602, the computing unit recognizes that the driver wants to take control of the vehicle from the control program 400. Preferably, in this case further input of the driver is monitored via input means and evaluated using sensors. At a subsequent program point 603, the computing unit records a behavior of the driver, that is, a state of the driver, for example based on active and passive inputs by the driver using the driver module 300, and stores these data in the database 302. In addition, the computing unit records a state of the vehicle, a position of the vehicle and/or other environmental parameters of the vehicle via other sensors and also stores them in the database 302.

At a subsequent program point 604, these stored data are marked as conflict data in the data memory and taken into account for further analysis. The conflict data indicate a situation in which the driver does not want automated control (for example, level 4) in longitudinal and lateral guidance of the control program 400. In a further embodiment, the conflict data may indicate a situation in which the driver input was unintended (e.g., an unintended steering input) or conflicted with the current safe driving state of the control program 400. At the following program point 605, the method ends.

FIG. 5 shows a schematic representation of a method for predicting a conflict. This method is executed by the prediction module 304. Upon the start at program point 700, the vehicle is in a manual mode, at which the vehicle is controlled by the driver by corresponding inputs in the longitudinal and/or lateral guidance, or in an at least partially automated mode, in which the longitudinal and/or lateral guidance of the vehicle is controlled by the control program 400.

At a subsequent program point 701, the position of the vehicle and/or the driving mode and/or the state of the driver and/or other environmental information is compared with conflict data in the database 302. For example, in step 701, a pattern of values (e.g., geolocation of the vehicle, current driver status, etc.) is compared with existing patterns in the pattern database 302 that represent a conflict situation. This pattern database may be evaluated in terms of the frequency of, e.g., control takeovers (based on previously recognized and recorded conflicts). For example: the current geolocation is compared with known geolocations associated with conflicts in the database. If the vehicle approaches the known geolocation of a conflict, further measures may be taken. If, at a subsequent program point 702, this check reveals that maintaining the manual driving mode involves a high probability of conflict with the driver's desire, the program branches to program point 703.

For example, a conflict may be determined by a direct interaction (see FIG. 4) and/or by applying context information when comparing with the database (see FIG. 5). If the first request 21 of the driver and/or the driver program 300 is at a functional limit of the control method or the control program 400 and/or in a dangerous state that is being checked by the safety program 200, a conflict is recognized. Furthermore, a conflict may be recognized if there is a specified conflict situation.

At program point 703, the control system 30 searches for a driving state with a lower potential for conflict based on the data in the database 302 and preferably other environmental information. In step 703, the pattern database 302 is searched for a driving state with a lower conflict potential. A driving state with a lower conflict potential is found if the conflict value of the pattern database in the evaluation unit 301 is smaller than the current conflict value of 702. The control system 30 subsequently switches to a driving state with the lower conflict potential at program point 704. The new driving state may, for example, require the switch of the control function from the driver to the control method or from the control method to the driver. At a subsequent program point 705, the method ends.

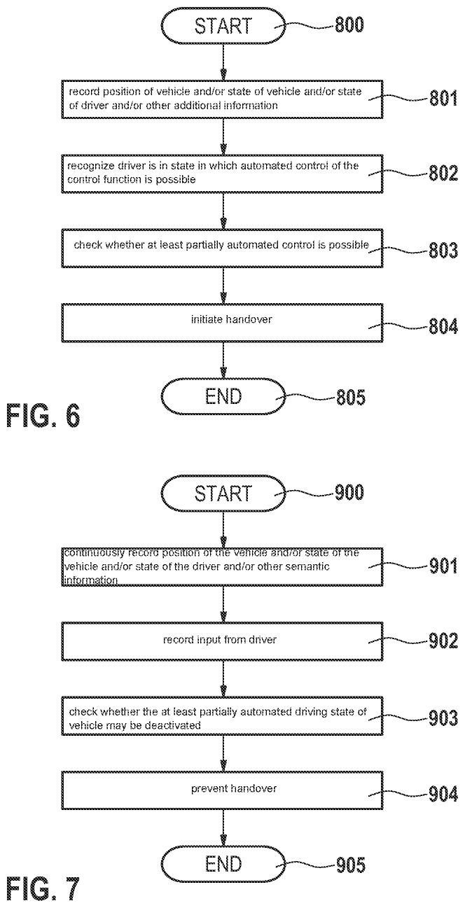

FIG. 6 shows a method sequence in which a handover is performed from manual control of the vehicle to at least partially automated control of the vehicle. The vehicle is in a manual control state upon the start at program point 800, in which the longitudinal and/or lateral guidance of the vehicle is controlled by the driver. At a subsequent program point 801, a position of the vehicle and/or a state of the vehicle and/or a state of the driver and/or other additional information is recorded using various sensors.

At a subsequent program point 802, the computing unit 3 recognizes that the driver is in a state in which automated control of the control function of the vehicle is possible in accordance with one of levels 2 to 5 of automated driving, in particular longitudinal and/or lateral control of the vehicle in accordance with the driver profile and/or in accordance with a safe state predetermined by the safety program 200. This is the case, for example, if the driver is in a poor state of health, the driver is asleep and/or the driver is inattentive.

In a subsequent program point 803, the control system 30 checks whether an at least partially automated control of the vehicle, in particular a highly automated control of the vehicle such as a level 4 control, for example depending on the position of the vehicle, depending on the state of the vehicle and in particular depending on the driver profile of the vehicle, is possible and/or desired. The activation of the automated control method (driving system) is initially a task of the control program 400, which determines whether the system can be activated based on geolocation data, sensor and automated driving system status, etc. The requests from the control program 400 should be fulfilled before it can be activated. The variables that are checked at program step 803 include, for example, the location at which level 4 of the operational domain begins or is about to begin, regulatory requirements, driving state (e.g., a safety threat), driver state (e.g., the driver is unfit to continue manual or partially automated control), etc. The activation of level 4 is also determined by the control system 30 through inputs from the safety program 200 and the driver program 300.

At a subsequent program point 804, the computing unit initiates a handover of at least part of the control function of the vehicle, i.e., the longitudinal and/or lateral guidance of the vehicle from the driver to the control program 400, if this is possible and/or desired depending on the state of the vehicle and, in particular, depending on the driver profile of the vehicle. In addition, the driver may be informed of the transfer of control responsibility from the driver to the control program 400 by a corresponding output from a user interface, in particular visually, haptically or acoustically. At a program point 805, the program ends.

FIG. 7 shows a method with which the partially automated control of the longitudinal and/or lateral guidance of the vehicle remains with the control program 400. At a program start 900, the vehicle is in an at least partially automated control mode for longitudinal and/or lateral guidance of the vehicle, in particular in a level 4 mode. At a subsequent program point 901, the position of the vehicle, the state of the vehicle, the state of the driver and/or other semantic information, in particular about the environment of the vehicle, is continuously recorded using sensors of the vehicle.

At program point 902, the computing unit 3 records an input from the driver, which is a prompt for the takeover of the control function of the longitudinal and/or lateral guidance of the vehicle from the control program 400 to the driver. The prompt to take over the control function may be recorded, for example, by a corresponding acoustic input from the driver and/or by a corresponding predetermined steering angle or a corresponding predetermined actuation of the brake pedal and/or a corresponding predetermined actuation of the gas pedal.

At a subsequent program point 903, the computing unit 3 checks whether, based on the position of the vehicle, the driver profile and/or the state of the driver, the at least partially automated driving state of the vehicle may be deactivated and the control of the longitudinal and/or lateral guidance of the vehicle is carried out manually by the driver.

For example, the deactivation of the automated driving system is a feature of the control program 400, which relies on geolocation data, sensors (e.g., cameras) and states of the automated driving system, etc., in order to determine whether the system may be deactivated. If any of the predetermined operational design domain requests from the control program 400 are not fulfilled, a deactivation process is initiated (e.g., handover of control back to the driver or a safe stop maneuver).

In program step 903, the location where the operational design domain of level 4 ends, the state of the driver (in order to check if he is fit to drive), administrative regulations, etc. are specified as variables. Whether or not the control of the driver may be safely executed is determined by the control system 30 based on inputs from the safety program 200 and the driver program 300.

If, at a subsequent program point 904, the computing unit 3 recognizes, for example on the basis of the driver profile and/or on the basis of the state of the driver, that a handover of the at least partially automated control mode of the longitudinal and/or lateral guidance of the vehicle to the driver is not possible, the handover of the control function of the longitudinal and/or lateral guidance of the vehicle from the control program 400 to the driver is prevented and, preferably, a corresponding output is output to the driver visually, acoustically and/or haptically via the user interface. At a subsequent program point 905, the method ends.

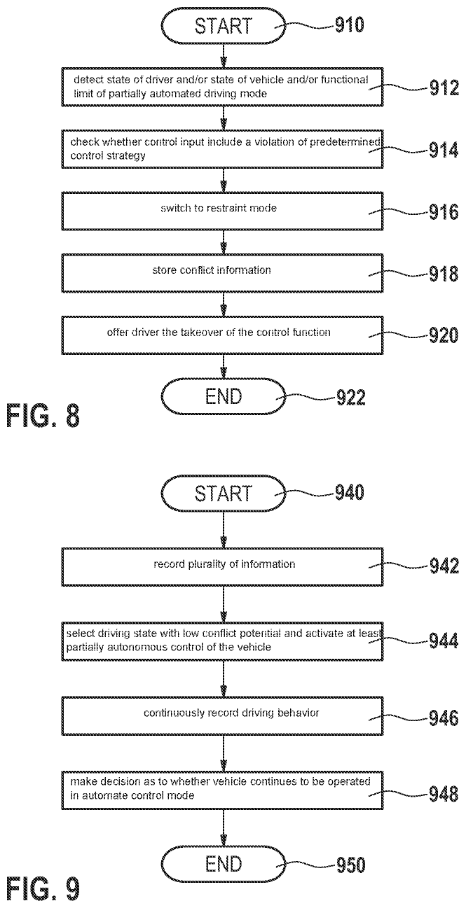

FIG. 8 shows a further method sequence, in which the vehicle is in an at least partially automated control mode for longitudinal and/or lateral guidance upon the start at program point 910. At program point 912, using sensors, a state of the driver, a state of the vehicle and/or a functional limit of the partially automated driving mode is detected, and control inputs are recorded by the driver. Control inputs include steering torque, brake pressure, gas pedal actuation, volume of the driver's voice and/or gesture control by the driver.

At a following program point 914, the computing unit 3 checks, based on the recorded control inputs of the driver, whether other information, such as legal regulations, reliability of the operation of the computing unit, reliability of the recording of the environment using the sensors of the vehicle, state of the driver, state of the vehicle, whether the control inputs include a violation of a predetermined control strategy.

A violation of a predetermined control strategy is recognized, for example, if any threshold value of a parameter, which are predetermined parameters of the system strategy such as the driver is drunk or asleep or sick, is exceeded; the geolocation of the vehicle indicates that driving in a certain mode, e.g., one of the modes level 0 to 5, is not allowed; the driver makes an inappropriate control request (e.g., steering into an obstacle). The parameters and the threshold values to be met are known to the safety program 200, and when a threshold value is exceeded, it is output as a safety value 23, and the control system 30 determines a corresponding action, along with other inputs, to bring the parameter back below the threshold value.

The control strategy may, for example, specify maintaining the at least partially automated driving mode, i.e., automated control of the vehicle using the control method in accordance with one of levels 2 to 5, if the safety of the computing unit and/or the vehicle or legal regulations are violated. For example, the control strategy may require the control program to take over the control of the vehicle that is being executed by the driver with respect to at least partially automated control of the vehicle in the event that the safety of the computing unit and/or the vehicle and/or legal regulations are violated.

Conflict parameters of a conflict situation that constitute or indicate a violation of the control strategy are, for example: oversteering of the vehicle, i.e. steering too hard so that there is a risk of the vehicle swerving sideways; impermissible brake application or gas pedal application; impermissibly high volume of the driver's voice; inconsistent gesture control by the driver; inappropriate state of the driver, in particular a sleeping driver, an unconscious driver, a driver under the influence of drugs (alcohol), an impermissible posture of the driver, in particular a reclined driver.

At a subsequent program point 916, the driving state of the vehicle is switched to a restraint mode and the driver is prevented from gaining control of a control function of the vehicle. At the same time, using a user interface, an output to the driver may be performed, which informs him that the control of the vehicle in the at least partially automated control mode of the control function, in particular the longitudinal and/or lateral guidance of the vehicle, remains with the control method or is transferred from the driver to the control method.

In particular, the restraint mode is activated if the following situation occurs: the input of the driver leads to a violation of the predetermined control strategy or passive inputs of the driver, i.e. the state of the driver, lead to a violation of the predetermined control strategy and thus represent a conflict situation. A haptic, visual or acoustic output, which indicates that the at least partially automated control mode of the vehicle is being maintained by the control program 400 or is transitioning to the control program 400, may be provided via the user interface.

At program point 918, this conflict situation is stored, wherein in particular combinations of active and passive inputs by the driver and a corresponding indication of the conflict situation are stored in the database 302. In addition, this information is stored with the driving mode and/or the state of the vehicle and preferably other data such as the state of the driver. This information may be used in the future to determine a prediction for a driver desire.

For example, the following data are stored in the case of a conflict situation: active inputs of the driver to control the vehicle, such as steering torque, brake pressure by the brake pedal, actuation of the gas pedal, voice volume of the driver in the case of acoustic control, gesture behavior of the driver in the case of gesture control. In addition, the following passive driver inputs, i.e. a state of the driver, may be recorded and stored during a conflict situation: driver's body position or deviation of the body position from an average driver's driving position, driver's blinking behavior. The data may be stored in the data storage 4 of the vehicle or in an external data storage such as a cloud database.

At a subsequent program point 920, depending on the detected conflict situation and the control strategy, after the conflict situation has been resolved by the user interface, the driver may be offered the takeover of the control function via the at least partially automated control of the longitudinal and/or lateral guidance of the vehicle currently executed by the control program 400. Program point 920 can also be dispensed with. The program subsequently ends at program point 922.

The user interface can output the takeover of the control function of the vehicle to the driver visually, acoustically or via a connected device such as a cell phone. The takeover may be executed by a corresponding input of the driver.

The method according to FIG. 8 may be used, for example, in a situation if the driver wants to start an overtaking maneuver although a vehicle is approaching from behind in a field of view that is not visible to the driver, i.e. in the blind spot. In accordance with the method according to FIG. 8, this leads to the at least partially automated control of the vehicle being maintained by the control program and prevents the driver from taking over control of the vehicle, in particular the longitudinal and/or lateral guidance of the vehicle. Moreover, in this situation, the data are stored in the database as conflict patterns.

FIG. 9 shows a method with which a driver desire based on a driver profile is predicted and taken into account in order to increase the driver's comfort and preferably to avoid a conflict situation.

At program start 940, the vehicle is in a manual driving mode, in which the vehicle is controlled by the driver. At a following program point 942, the computing unit 3 records a plurality of information using the sensors of the vehicle and checks this with respect to conflict situations, such as legal regulations and/or safety issues and/or a state of the vehicle and/or a state of the driver. In addition, the state of the driver, the state of the vehicle, a functional limit of the at least partially automated control method, control inputs by the driver and/or a conflict data of the database may be checked for the presence of a possible conflict situation. A conflict may be determined if there is a direct interaction (see FIG. 4) and/or if context information is compared to data from the database (see FIG. 5) and these show that the current context information is associated with a conflict situation.

If the comparison shows that the present driving situation represents a conflict situation, then the program branches to program point 944.

For example, when a functional limit of the at least partially automated control method is reached, the following information is recorded: position of the vehicle with respect to a road situation, such as driving on a highway, driving in a city, driving on a country road, driving in a tunnel, driving onto a highway, driving into an intersection, etc., presence of lane markings, in particular lane boundaries, readiness of the driver for the handover of a control function of the vehicle to the at least partially automated control method by the control program 400.

At program point 944, the computing unit selects a driving state with a low conflict potential and activates, for example, at least partially automated control of the vehicle by the control program. In this situation, the output of information to the driver that the control of the vehicle has been taken over by the control program may be dispensed with. In addition, other states of the vehicle may be set depending on a previously set driver profile.

A low conflict potential is specified depending on context information and/or a driver profile and/or stored conflict situations. A low-conflict state is determined based on current context information (system state, environmental state, available automation mode, etc.) compared with information stored in the database, and searching for combinations of these factors that are least likely to be associated with a conflict.

Conflict database and conflict prediction are used in combination and employed to output the probability of a conflict. The probability of a conflict is determined by the frequency with which similar conflicts have occurred (e.g., same driver status, same road type, same geolocation, etc.). The solution can then be searched in the database by frequency.

Upon the transfer to at least the partially automated control method of the vehicle by the control program 400, a highly automated driving mode may be activated (level 4 or level 5), for example. In addition, the tilt of the driver's seat may be changed to a reclined position, for example. In addition, the pedals for the gas, clutch and/or brake or alternative control elements may be moved to a rest position outside an actuating range of the driver. In addition, it may be offered to the driver that data for entertainment, in particular music or film, is output using a user interface.

For example, the driver profile may include a driving mode for partially automated control of the vehicle. In addition, the driver profile may include preferred specifications for the length, for the frequency, and depending on the state of the driver or the state of the vehicle, for a handover of the driving function from the driver to the at least partially automated control method. In addition, the driver profile may contain the information that the vehicle should be operated as often as possible and for as long as possible with a predetermined level, e.g. level 2 to level 5, of the automated control method, in particular with the highest level of the automated control method. Furthermore, a preferred sitting position may be predetermined during automated control of the vehicle. Furthermore, adaptive learning of the driver profile may be switched on or off by the driver. In addition, settings for the climate control or lighting may be predetermined as driver profiles.

At a subsequent program point 946, the computing unit preferably continuously records a driving behavior of the driver based on active and/or passive inputs, i.e. a state of the driver depending, for example, on the steering angle, brake actuation, a microphone, etc. This information is stored in a pattern database and associated with a driving mode and a driving state.

For example, a steering torque, a brake pressure by the driver, an actuation of the gas pedal by the driver, a volume of the driver's voice, a gesture by the driver may be recorded and stored as active or passive inputs of the driver. As passive driver inputs, for example, a driver's posture, particularly relative to a predetermined sitting position, or a frequency of eye blinking (closing and opening of the eyelids) that indicates fatigue, may be recorded. The data regarding the state of the vehicle and/or regarding the state of the driver may be stored in the data memory of the vehicle and/or outside the vehicle, for example in a cloud.

At a subsequent program point 948, based on a driver profile, an evaluation of the driver inputs, a comparison with conflict data of the database, the position of the vehicle and/or the environment of the vehicle, a decision is made by the computing unit 3 as to whether the vehicle continues to be operated in the automated control mode or whether the control of the longitudinal and/or lateral guidance is again at least partially offered to the driver. In addition, the computing unit may check whether driver inputs violate a control strategy and therefore control remains with the automated control method.

The driver may be offered the takeover of the control of the longitudinal and/or lateral guidance of the vehicle visually or acoustically via a user interface of the vehicle or via a further mobile device of the driver, such as a cell phone.

The control system is held back during the control method if active or passive inputs from the driver exceed or fall below predetermined threshold values. For this purpose, corresponding information may be output to the driver via the user interface haptically, visually or acoustically, indicating that control of the vehicle remains with the control method.

The control function is retained in the control method 400 if safety regulations and/or legal requirements are violated by the driver's active or passive inputs.

In addition, a handover of the control function from the driver to the control program is executed if safety regulations or legal requirements are violated by the driver's active or passive inputs. In this case, there is a switch from manual control to at least partially automated control of the longitudinal and/or lateral guidance of the vehicle, in particular highly automated control of the longitudinal and/or lateral guidance of the vehicle. Conflict parameters that may constitute a safety violation include, for example, oversteering, invalid brake application and/or invalid gas pedal application, invalid driver volume, inconsistent driver gesture behavior, a sleeping driver, an unconscious driver or an intoxicated driver (excessive alcohol content) or driver posture inappropriate for controlling the vehicle.

What is claimed is:

1. A computer-implemented method for switching a control function of a vehicle between a driver and an at least partially automated control method for controlling the vehicle, the method comprising the following steps:
recording a stored driver profile;
recording a state of the driver and/or a state of the vehicle and/or a state of the control method; and
switching the control function of the vehicle between the driver and the control method depending on the driver profile and depending on the state of the driver and/or the state of the vehicle and/or the state of the control method.

2. The method according to claim 1, wherein the switch of the control function of the vehicle between the driver and the control method for controlling the vehicle takes into account a stored conflict situation that prohibits or requires a switch of the control function between the driver and the control method, wherein the conflict situation corresponds to a predetermined state of the driver and/or a predetermined state of the vehicle and/or a predetermined state of the control method.

3. The method according to claim 1, wherein the control method specifies, depending on the driver profile, a frequency of requests from the control method for a switch of the control function between the driver and the control method.

4. The method according to claim 1, wherein the control method executes requests for a takeover of the control function and/or requests for a handover of the control function depending on the driver profile at different states of the vehicle.

5. The method according to claim 1, further comprising:
based on a request of the control method for a takeover of the control function that is being executed by the driver, or based on a request for a handover of the control function to the driver that is being executed by the control method, checking whether a state of the vehicle predetermined by the driver profile is present, and wherein the request for the handover and/or the takeover of the control function is executed when the state of the vehicle predetermined by the driver profile is present.

6. The method according to claim 1, wherein, depending on the driver profile at predetermined states of the driver, the control method executes a request to the driver for a takeover of the control function that is being executed by the driver and/or the control method executes a request to the driver for a handover of the control function that is being executed by the control method.

7. The method according to claim 1, further comprising:
based on a request from the control method to the driver for a takeover of the control function of the vehicle that is being executed by the driver, or based on a request from the control method to the driver for a handover of the control function of the vehicle to the driver that is being executed by the control method, checking whether a state of the driver predetermined by the driver profile is present, and wherein the request for the handover and/or the takeover of the control function of the vehicle is executed when the predetermined state of the driver is present.

8. The method according to claim 1, wherein the driver profile is determined in such a way that at least one state of the driver and/or at least one state of the vehicle are recorded when the driver requests a takeover of the control function of the vehicle that is being executed by the control method, or when the driver takes over a handover of the control function of the vehicle that is being executed by the control method, and wherein the driver profile is specified depending on the recorded state of the driver and/or depending on the recorded state of the vehicle.

9. The method according to claim 1, wherein the driver profile specifies a functional limit, wherein the control method, when the functional limit is reached, offers to the driver the handover of the control function of the vehicle that is being executed by the control method.

10. A computer-implemented method for determining a driver profile for carrying out a switch of a control function of a vehicle between a driver and an at least partially automated control method for controlling the vehicle, the method comprising the following steps:
during operation of the vehicle, based on a request from the control method and/or based on a request from the driver for a switch of the control function, checking whether or not the switch is taking place; and
storing a state of the driver and/or a state of the vehicle and/or a state of the control method in the driver profile together with the request from the control method and/or the request from the driver for the switch of the control function, and information as to whether or not the switch took place.

11. The method according to claim 10, further comprising:
offering, by the control method to the driver, the handover of the control function when a functional limit of the control method is reached;
monitoring whether or not the driver accepts the handover;
recording at least one state of the driver and/or at least one state of the vehicle, wherein the recorded state of the driver and/or the recorded state of the vehicle are stored as a driver profile; and
storing the information is stored as to whether or not the driver has accepted the handover of the control function.

12. The method according to claim 10, wherein at least one of the following parameters is recorded as the state of the driver: steering torque by the driver, steering angle by the driver, pressure on the brake pedal by the driver, actuation of the gas pedal by the driver, volume of the driver's voice, movement behavior of the driver including movement behavior of the driver in the case of gesture control, sitting position of the driver, direction of gaze of the driver, number and/or frequency of closing of the driver's eyes, state of health of the driver, state of wakefulness of the driver and/or state of sleep of the driver.

13. The method according to claim 10, wherein at least one of the following parameters is recorded as the state of the vehicle: position of the vehicle, road situation in the area of the vehicle, in particular position of the vehicle at an entry into a road or in an exit from a road or in an entrance to an intersection, number of lanes of a road in the area of the vehicle, presence of road markings, presence of lane boundaries, weather situation in the area of the vehicle, in particular rain, snow, wind force, speed of the vehicle, acceleration of the vehicle in the longitudinal direction and/or in the lateral direction and/or level of the automated control method of the vehicle including level 2 to level 5 of the automated control method.

14. A computing unit configured to switch a control function of a vehicle between a driver and an at least partially automated control method for controlling the vehicle, the computing unit configured to:
record a stored driver profile;
record a state of the driver and/or a state of the vehicle and/or a state of the control method; and
switch the control function of the vehicle between the driver and the control method depending on the driver profile and depending on the state of the driver and/or the state of the vehicle and/or the state of the control method.

15. A non-transitory computer-readable medium on which is stored a computer program including instructions switching a control function of a vehicle between a driver and an at least partially automated control method for controlling the vehicle, the instructions, when executed by a computing device, causing the computing device to perform the following steps:
recording a stored driver profile;
recording a state of the driver and/or a state of the vehicle and/or a state of the control method; and
switching the control function of the vehicle between the driver and the control method depending on the driver profile and depending on the state of the driver and/or the state of the vehicle and/or the state of the control method.
